(19) United States
(12) Patent Application Publication
(10) Pub. No.: US 2008/0243311 A1
(43) Pub. Date: Oct. 2, 2008

(54) Switchgear Cabinet Control System and Monitoring System

(76) Inventors: Ralf Dahmer, Olpe (DE); Timo Prommersperger, Leun (DE); Heinrich Strackbein, Biebertal (DE); Sven Laurosch, Haiger (DE); Daniel Rosenthal, Siegen (DE); Jorg Kreiling, Biebertal (DE)

Correspondence Address: PAULEY PETERSEN & ERICKSON, 2800 WEST HIGGINS ROAD, SUITE 365, HOFFMAN ESTATES, IL, 60195, US

(21) Appl. No.: 11/795,488

(22) PCT Filed: Dec. 28, 2005
(86) PCT No.: PCT/EP05/14086

§ 371 Date: Apr. 18, 2008

(30) Foreign Application Priority Data
Jan. 17, 2005 (DE) 10 2005 002 314.2

(51) Int. Cl. G05B 23/02

(52) U.S. Cl. 700/286

(57) ABSTRACT

A switchgear cabinet control system and a monitoring system including at least one switchgear cabinet, a control and monitoring device and an operating and information system including user components and data processing, data transferring and storage components which can be remote controlled, in addition to a user guiding device and a configuration device. An individually adapted, simple to operate system is obtained when the operating and information system includes a planning device which is used to selectively combine at least one switchgear cabinet having switchgear cabinet components to an individual user system in a provider device, wherein offer-related data of various switchgear cabinets and switchgear cabinet components are contained. A selected arrangement of planned data which is related to at least one switchgear cabinet and switchgear cabinet components can be extracted therefrom.

### BACKGROUND OF THE INVENTION

1. Field of the Invention

This invention relates to a control and monitoring system for a switchgear cabinet, having at least one switchgear cabinet, a control and monitoring arrangement and an operating and information system, which has user components for remote control, as well as data processing, data transfer and memory components, a user guide arrangement and a configuration arrangement.

2. Discussion of Related Art

A control and monitoring system for a switchgear cabinet is disclosed in European Patent Reference EP 1 260 001 B1, embodied within the framework of a switchgear cabinet air conditioning arrangement and that relates to monitoring and control of a cooling device for a switchgear cabinet, which has a server and can be operated from a remote location via a web. The operating unit which, for example, contains a personal computer, offers clear operating options by a customary web browser which is assigned to the personal computer. Various data can be stored in the remote server assigned to the cooling device, for example documents relating to the structure and the operation of the cooling device, so that the data can also be made visible on the control area of the personal computer and can be used, for example, for checking the settings of the cooling device and, if required, to reset the settings in the required manner. During this, the user has various setting options, wherein the user possibly must take all manner of system prerequisites into consideration.

A control and monitoring arrangement, which goes beyond the control and monitoring possibilities of the switchgear cabinet per se, for example is not merely restricted to a cooling device control, and also not to an air conditioning arrangement for a switchgear cabinet, is disclosed in PCT International Publication WO 97/34345, which provides a more extensive basis. In connection with this known control and monitoring arrangement, different monitoring and control components for states of built-in units and/or add-on units of the switchgear cabinet are connected, in part via intermediate units, to a central control device for controlling and monitoring a switchgear cabinet for data exchange. The air conditioning unit comprises various air conditioning components, inter alia heat exchangers, fans, cooling apparatus, one or several heaters and/or user ventilators, which the user can connect as desired. Also, a number of different sensors are provided, such as moisture and condensation sensors, door limit switches, temperature sensors, vibration sensors, smoke detectors, transducers for current and/or voltage, and supply devices for network-supplied or, for example, battery-buffered power supply. Furthermore, there are programming and connecting units for remote maintenance, as well as local indicator units. This control and monitoring arrangement in connection with a switchgear cabinet allows use of the switchgear cabinet under many different employment conditions of quite different types, for example in an atmosphere of high temperature, or in humid areas, or in surroundings endangered by vandalism wherein the respective settings presuppose an appropriate knowledge and can be best performed by a specialist.

Also, known patents and patent applications are directed to different combinations of control and monitoring arrangements in switchgear cabinets and, for example, relate to a master/slave arrangement, in which a control and monitoring unit is connected as the master with further control and monitoring units operating as slaves, possibly over large distances, for example via a local network.

Such control and monitoring arrangements for switchgear cabinets, or racks, which permit flexible utilization options for one or several connected switchgear cabinets, are also considered.

### SUMMARY OF THE INVENTION

One object of this invention is to provide a control and monitoring system for a switchgear cabinet, which offers the user flexible, individual utilization options for a switchgear cabinet or a switchgear cabinet arrangement, which can be adapted in a simple manner.

This object is attained according to characteristics described in this specification and in the claims. In one vendor arrangement, the operating and information system contains a planning arrangement for the selective combination of at least one switchgear cabinet with switchgear cabinet components into an individual user unit, in which vendor data from different switchgear cabinets and switchgear cabinet components are contained, from which a selected arrangement of planning data from at least one switchgear cabinet and regarding switchgear cabinet components can be extracted.

The operating and information system thus designed permits a user to create a user installation which is exactly matched to individual requirements which then, after creating the installation, offers simple operating and monitoring options for it. Because the vendor or the factory compute the data as a function of components generated by the user inside a switchgear cabinet and/or several switchgear cabinets, into planning data, the latter are exactly tailored to the generated individual user installation. Without superfluous additional data, they offer the user the possibility to make desired settings in a simple manner by the user guide arrangement and the appropriately matched control area of the visual display device and the input devices in the generated installation.

Here, the operating possibilities for the user are further simplified because the data processing components are designed for linking the planning data and, on their basis, for generating configuration data by the configuration arrangement, wherein the configuration data include individual installation data. Here, the configuration data result in an automatically and exactly matched interface for the control and monitoring of the individual user installation.

A further simplification for the user results if the installation data are included during control and monitoring of the physical states of the at least one switchgear cabinet by the operating and monitoring components. Because of the automatic inclusion of the installation data, or possibly the configuration data including these, the user does not need to individually enter them, but instead can read them into the control and monitoring arrangement, for example by the available software.

One embodiment is advantageous because the configuration data include parameter data, which are tailored to the user installation and contain setting data and/or output data of the components.

Operation of the individual user installation is simplified because the data processing components are designed for generating control and monitoring data in a monitoring and control data generating device of the vendor device, which can be supplied to a control and monitoring arrangement of the user installation created in accordance with planning data for controlling and monitoring the latter. With the control and monitoring data automatically generated in this way, the user can easily operate the installation wherein, if desired, he can also easily perform changes in parameter settings, for example threshold values, alarm limits.

There are advantageous possibilities of making data available to the user because the control and monitoring data generated by the vendor are made available to a user on a portable data support or because they can be called up from a memory of the vendor device for reading them into the control and monitoring arrangement of the user installation.

An advantageous construction of the installation results from one control and monitoring arrangement per user installation provided.

In a further embodiment, several control and monitoring components exist per control and monitoring arrangement. In this case, the control and monitoring components can be, for example, cooling devices, different air conditioning units, sensor units, energy supply units or actuating members.

A further advantageous construction results when several switchgear cabinets are in a user installation, and several control and monitoring units are linked together in the monitoring and control arrangement. In this way, the control and monitoring of individual switchgear cabinets can be combined into a common control and monitoring unit, in particular via a local network, wherein for example one control and monitoring unit is designed as master, and the others as slaves.

### BRIEF DESCRIPTION OF THE DRAWINGS

This invention is explained in greater detail in view of exemplary embodiments, making reference to the drawings, wherein:

FIG. 1 shows a switchgear control and monitoring system in a schematic block representation;

FIG. 2 shows a diagram of an operating element on the part of the user;

FIG. 3 shows a visual display on the part of the user for an installation configuration with an operating element, in accordance with FIG. 2;

FIG. 4 shows another representation on a visual display, in accordance with FIG. 3;

FIG. 5 shows a visual display of or for the user, for a control and monitoring operation; and

FIG. 6 shows a visual display in accordance with FIG. 5 with a different representation in the control and monitoring operation.

### DETAILED DESCRIPTION OF THE INVENTION

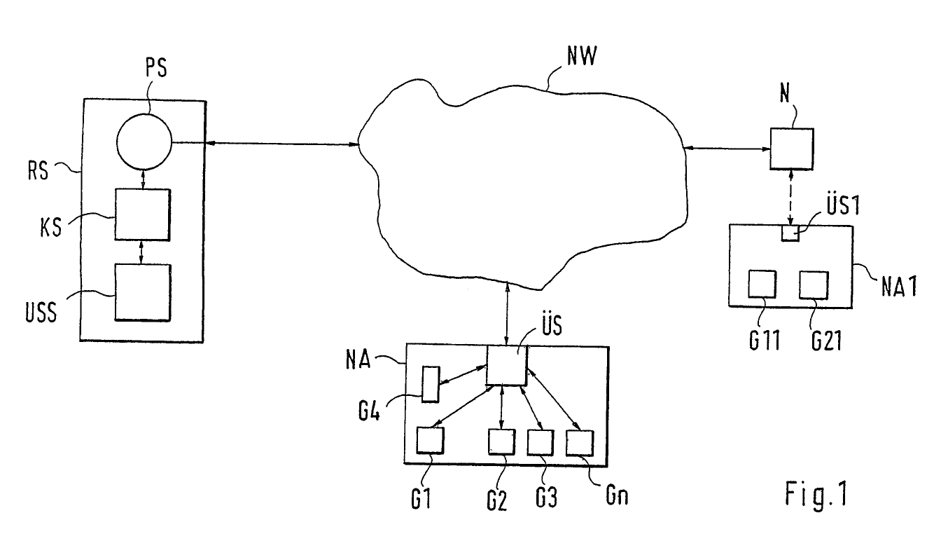

The switchgear control and monitoring system schematically represented in FIG. 1 has a vendor arrangement RS on the part of the factory or vendor, which is connected, for example, to a publicly accessible network or net NW, through which a user N, also connected via the network NW to the customer side, can call up vendor data in order to individually put together an installation of one or several switchgear cabinets, and possibly switchgear cabinet components, to be assembled. If the user N has assembled and acknowledged an individual installation, this user installation NA, NA1 is delivered in accordance with his order and installed and is, for example, also connected to the publicly accessible network or to an internal company network, or is linked to a local network, so that the user N can also check and operate at least one user installation NA, NA1 from a remote location.

The vendor arrangement RS has a planning arrangement PS for making the vendor data available, in which the various switchgear cabinets, racks, switchgear cabinet components and the like offered by it, are electronically stored, for example in the form of catalogs or other representations. In this case, information regarding their properties, dimensions and, if required, physical values, such as power requirements or output, which can be made available, is also assigned to the switchgear cabinets, or components, besides their pictures and ordering data. The customer can assemble an individual user installation by these vendor data in real time, on line. The planning arrangement PS is embodied, for example, so that the customer can also enter spatial conditions and can insert individual wishes, or requirements, interactively. For example, the geometric dimensions of premises, properties of the room air conditioning such as, for example, removal of the waste heat via the ceiling and supply of cold air via the floor, or usage of the room, can be entered. It is possible when planning to also consider such requirements on the part of the customer.

Furthermore, the vendor arrangement RS contains a configuration arrangement KS, by which the data obtained during planning are converted to configuration data. For example, the configuration arrangement KS is embodied so that it links properties of the components, on which the planning data are based, together in order to make available as effective as possible an assembly of the components in accordance with the requirements of the customer, possibly by data exchange with the planning arrangement PS, and to also suitably select physical parameters. For example, in a room where people are present it can be practical to operate fans as quietly as possible during working hours, while at other times of the day as low as possible an energy use is brought into the foreground. Appropriate programs, which react to customer requirements, are provided in the configuration arrangement KS for such a conversion of the planning data into configuration data.

Furthermore, an arrangement ÜSS for generating monitoring and control data is arranged in the vendor arrangement RS. Monitoring and control data are generated using the arrangement ÜSS for generating monitoring and control data which, at the termination of the generation of the planning data and configuration data, are made available to the user, for example stored on a portable data support such as a CD, a memory card, a memory stick or in a memory device of the vendor, for access via the network NW in accordance with the composition of the individual user installation NA, NA1.

The user installation NA, or NA1, is constructed by the user N in accordance with the composition of the individual user installation NA, NA1, and is connected, either via the network NW or via another data transmission path, depending on the wishes of the user N, to an operating arrangement of the user N. In this case, the user installation NA, for example, has several switchgear cabinets G1 . . . Gn, which can perform different functions, for example can receive servers, can be equipped with a supply device for an interruption-free electric current supply, and/or can include a cooling arrangement. The user installations NA, NA1 each have a control and monitoring arrangement ÜS, or ÜS1, which can also be in a data exchange connection, for example via the user N, such as a data processing installation. Here, the control and monitoring arrangement ÜS, ÜS1 is constructed, for example, of several control and monitoring units, which are in connection with each other, for example, via a local network. In this case, it is practical if each switchgear cabinet G1 . . . Gn, or G11, G21, is respectively assigned its control and monitoring unit. In the control and monitoring arrangement ÜS, or ÜS1, constructed in this way, the construction is provided so that one of the control and monitoring units is designed as master, and the remaining ones as slaves, which make their data available to the master, wherein the master takes over the main control function and, depending on the programming, can act on individual control and monitoring units. If one switchgear cabinet exists, it is useful to only use one central control and monitoring arrangement, which is supplied with the data from the various monitoring and control components present in the switchgear cabinet, or with which the data are exchanged in case of a bidirectional connection, such as represented in PCT International Publication WO 97/34345.

Because, as described above, the user N has the data of an individually compiled user installation NA, or NA1, following the construction of the user installation the user can send them to the appropriate control and monitoring arrangement ÜS, ÜS1, for example from an operating device or a work station in connection with its control area, wherein there is a user guide arrangement. Another option includes the data, control and monitoring data, directly provided at the location of the control and monitoring arrangement ÜS, ÜS1 by the customer. In any case, following the provision of the control and monitoring data, the respective control and monitoring arrangement is exactly matched by corresponding to the individual construction of the user installation NA, NA1 to the latter, so that the user N, by the control area, can perform specific remote maintenance or remote control without unnecessary additional information.

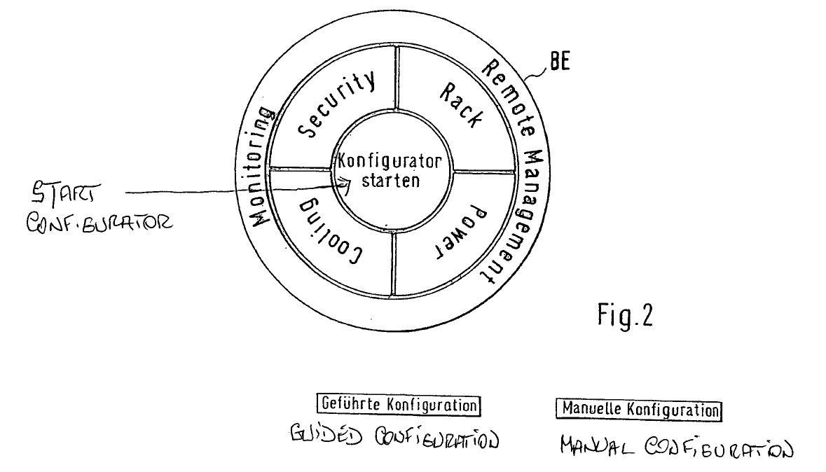

FIG. 2 shows an example of a control element BE by the user in the form of an operating button having several elements, which are assigned to different functions, shown on the visual display of the user N. For performing the configuration of the user installation NA, NA1, the user uses the control button “start configurator”, for example, and then can display different components, also in regard to their function and effects, on the visual display.

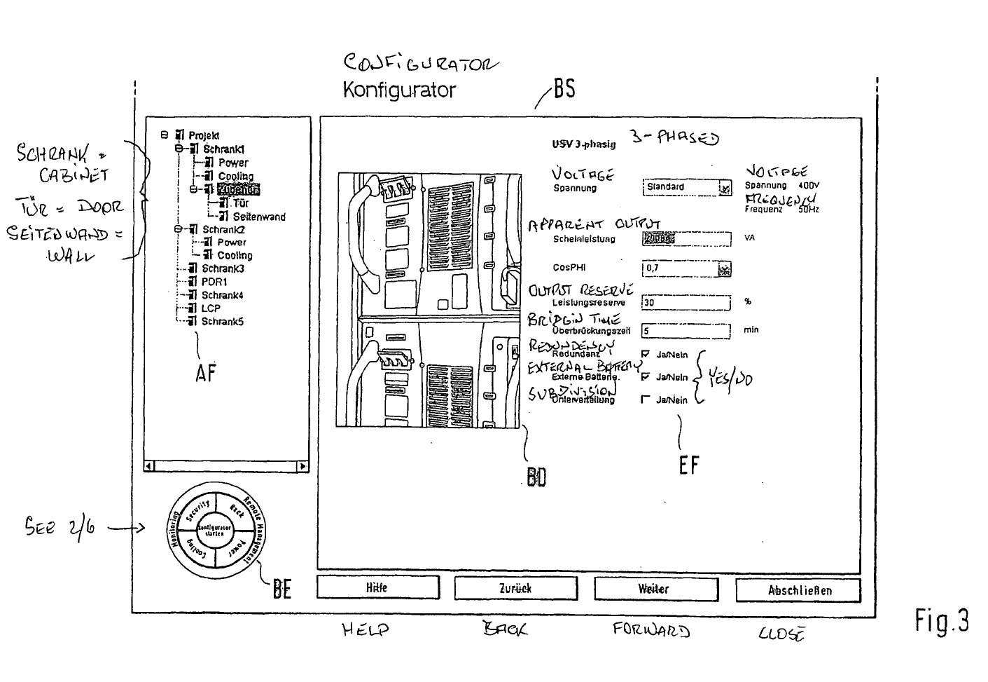

FIG. 3 shows by way of example a visual display BS during the operation of the configurator, wherein information regarding the installation are displayed in an installation field AF, a pictorial representation of the respective components in an image representation field BD, and physical properties in an adjusting field EF, on the user visual display BS, on which the control element BE is also represented.

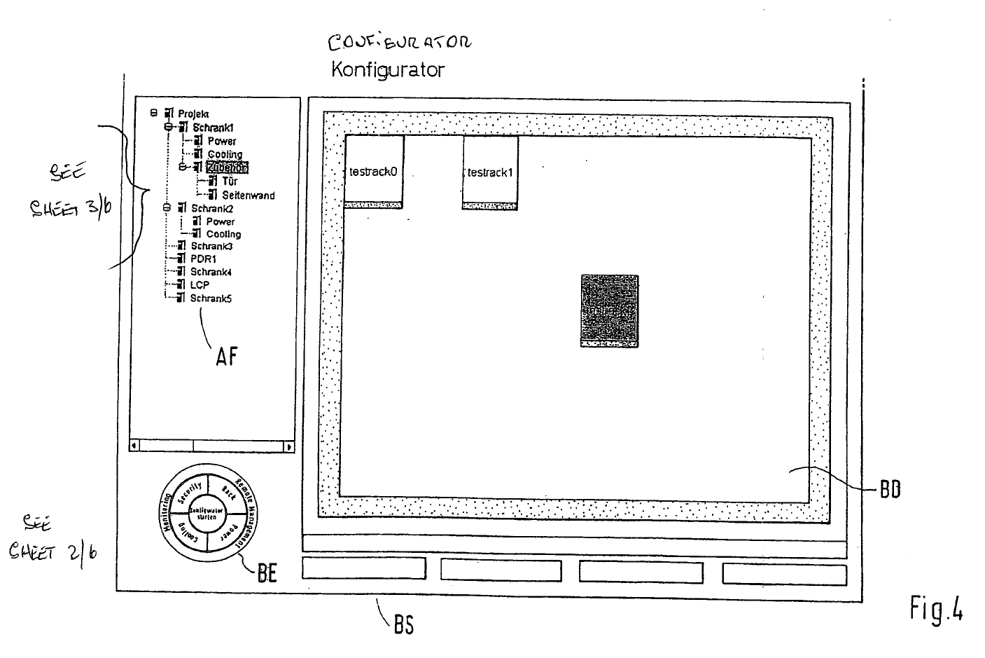

FIG. 4 shows another representation on the user visual display BS during configurator operations, wherein an arrangement of several switchgear cabinets in a room of the customer, for example a computer room, is represented on the image representation field BE, which is enlarged in comparison with FIG. 3.

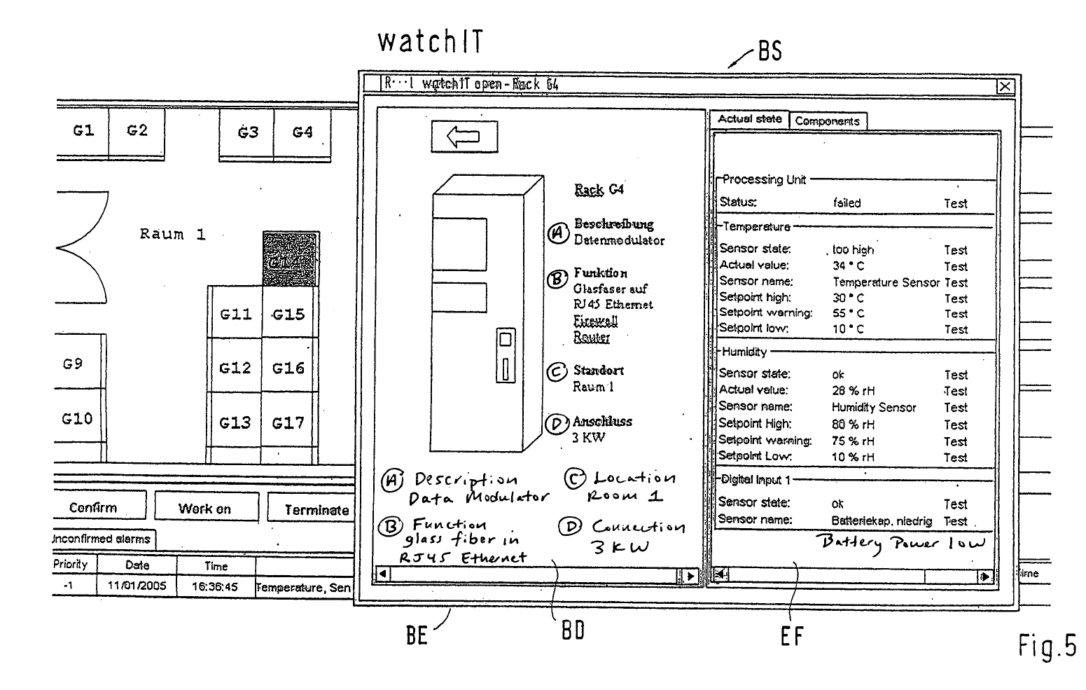

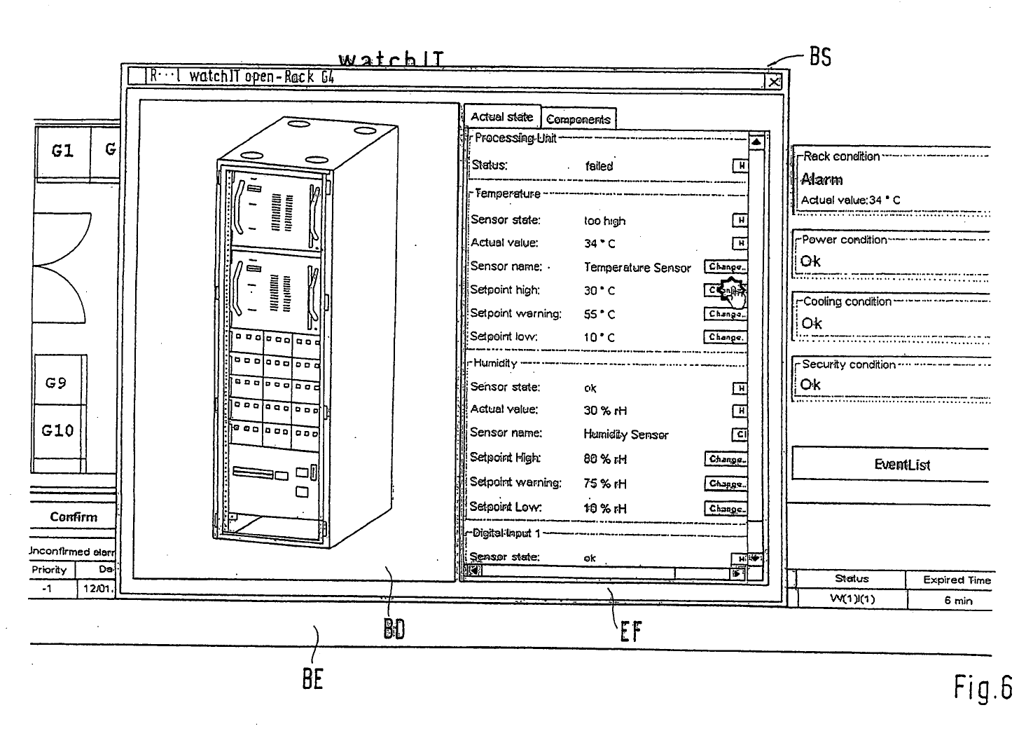

FIGS. 5 and 6 show different representations on the user visual display BS during a check or operation during control or monitoring operations of the already generated user installation NA, NA1. On the control area, the user can represent premises with the user installation NA, NA1, and can have the conditions in one of the switchgear cabinets G1 . . . Gn represented, for example, wherein a known per se window technique is used. It is also possible to check individual components inside a rack or cabinet. If desired, other settings can be provided. Also, monitoring of the entire room, for example, by a net camera installed therein, or by other sensors installed therein, for example temperature and/or humidity sensors, is possible. As a function of the selected conditions it is then possible for the user to react accordingly by remote control.

Control and monitoring of the individual components in a total system, in which they depend on each other, becomes possible with the recited construction, so that points of view regarding a high degree of dependability and efficiency are met. An optimization of the construction is already achieved at the start of planning and with the configuration with simple remote operation. Modular air conditioning concepts and, beyond that, other control and monitoring concepts, can be achieved by monitoring and controlling the individual components. For example, control measures regarding the following functions and their monitoring can be achieved.

Analysis of the temperature course within the switchgear cabinets, or racks, monitoring of the air conditioning components, or cooling devices, inclusive of re-cooling installations, inflow, return flow, pressure, admission control, monitoring of the operational state of the interruption-free electrical current supply, analysis of the hours of operation of fans and installations for interruption-free electrical current supply, including preventive maintenance, active guidance of the energy supply, or of energy consumption, wherein possibly existing wall plug locations can be individually monitored and controlled, video monitoring of a server room and documentation and analysis of occurring errors by date and time.

1. A control and monitoring system for a switchgear cabinet, having at least one switchgear cabinet (G1 . . . Gn), a control and monitoring arrangement (ÜS, ÜS1) and an operating and information system having user components designed for remote control, data processing, data transfer and memory components, and a user guide arrangement and a configuration arrangement, the control and monitoring system comprising:
in a vendor arrangement (RS) the operating and information system containing a planning arrangement for selectively combining the at least one switchgear cabinet with switchgear cabinet components into an individual user unit NA, NA1) in which vendor data from different of the switchgear cabinets (G1 . . . Gn) and switchgear cabinet components are contained, from which a selected arrangement of planning data from the at least one switchgear cabinet and the switchgear cabinet components can be extracted.

2. The control and monitoring system for a switchgear cabinet in accordance with claim 1, wherein the data processing components link the planning data and, on their basis, are for generating configuration data by the configuration arrangement (KS), wherein the configuration data include individual installation data.

3. The control and monitoring system for a switchgear cabinet in accordance with claim 2, wherein installation data are included during control and monitoring of physical states of the at least one switchgear cabinet by the operating and monitoring components.

4. The control and monitoring system for a switchgear cabinet in accordance with claim 3, wherein the configuration data include parameter data tailored to the user installation (NA, NA1) and contain at least one of setting data and output data of the components.

5. The control and monitoring system for a switchgear cabinet in accordance with claim 4, wherein the data processing components generate control and monitoring data in an arrangement (ÜSS) for generating the monitoring and control data of the vendor arrangement (RS) which is supplyable to a control and monitoring arrangement (ÜS, ÜSS1) of the user installation (NA, NA1) created in accordance with planning data for controlling and monitoring the planning data.

6. The control and monitoring system for a switchgear cabinet in accordance with claim 5, wherein control and monitoring data prepared by the vendor are one of available to a user on a portable data support and for call-up from a memory of the vendor arrangement (RS), for reading into the control and monitoring arrangement of the user installation (NA, NA1).

7. The control and monitoring system for a switchgear cabinet in accordance with claim 6, wherein there is one control and monitoring arrangement (ÜS, ÜSS1) per the user installation (NA, NA1).

8. The control and monitoring system for a switchgear cabinet in accordance with claim 7, wherein with several switchgear cabinets (G1 . . . Gn) in a user installation (NA, NA1), several of the control and monitoring units are linked together in the control and monitoring arrangement (ÜS, ÜSS1).

9. The control and monitoring system for a switchgear cabinet in accordance with claim 2, wherein the configuration data include parameter data tailored to the user installation (NA, NA1) and contain at least one of setting data and output data of the components.

10. The control and monitoring system for a switchgear cabinet in accordance with claim 2, wherein the data processing components generate control and monitoring data in an arrangement (ÜSS) for generating the monitoring and control data of the vendor arrangement (RS) which is supplyable to a control and monitoring arrangement (ÜS, ÜSS1) of the user installation (NA, NA1) created in accordance with planning data for controlling and monitoring the planning data.

11. The control and monitoring system for a switchgear cabinet in accordance with claim 10, wherein the control and monitoring data prepared by the vendor are one of available to a user on a portable data support and for call-up from a memory of the vendor arrangement (RS), for reading into the control and monitoring arrangement of the user installation (NA, NA1).

12. The control and monitoring system for a switchgear cabinet in accordance with claim 1, wherein there is one control and monitoring arrangement (ÜS, ÜSS1) per the user installation (NA, NA1).

13. The control and monitoring system for a switchgear cabinet in accordance with claim 1, wherein with several switchgear cabinets (G1 . . . Gn) in a user installation (NA, NA1), several of the control and monitoring units are linked together in the control and monitoring arrangement (ÜS, ÜSS1).
